(19) United States
(12) Patent Application Publication
(10) Pub. No.: US 2025/0211089 A1
(43) Pub. Date: Jun. 26, 2025

(54) INVERTER CIRCUIT WITHOUT HIGH-SIDE POWER SWITCHES

(71) Applicant: UNIVERSITY OF ELECTRONIC SCIENCE AND TECHNOLOGY OF CHINA, Chengdu (CN)

(72) Inventor: Junhong LI, Chengdu (CN)

(73) Assignee: UNIVERSITY OF ELECTRONIC SCIENCE AND TECHNOLOGY OF CHINA, Chengdu (CN)

(21) Appl. No.: 18/864,563

(22) PCT Filed: May 12, 2023
(86) PCT No.: PCT/CN2023/093791

§ 371 Date: Nov. 11, 2024

(30) Foreign Application Priority Data
May 13, 2022 (CN) 202210517924.3

(51) Int. Cl. H02M 1/00; B60L 58/10; H02M 1/38; H02M 1/44; H02M 7/5395

(52) U.S. Cl. CPC H02M 1/0067; H02M 1/0054; H02M 1/385; H02M 1/44; H02M 7/5395; B60L 58/10; B60L 2210/40

(57) ABSTRACT

An inverter circuit and inverter module without high-side power transistors are provided. The inverter circuit consists of at least two inverter modules connected in a ring structure. Each inverter module includes: A pre-filter circuit, having a signal input terminal and a signal output terminal, wherein the signal input terminal serves as the modulation signal input terminal; A central filter circuit, including a DC power input terminal and an AC power output coil, with the signal input terminal of the central filter circuit connected to the signal output terminal of the pre-filter circuit; A signal output circuit, with its signal input terminal connected to the signal output terminal of the central filter circuit, and its signal output terminal serving as the modulation signal output terminal. The inverter circuit and the inverter module enable a significant reduction in inverter costs and simplifies the controller algorithm.

### CROSS REFERENCE TO THE RELATED APPLICATIONS

This application is the national phase entry of International Application No. PCT/CN2023/093791, filed on May 12, 2023, which is based upon and claims priority to Chinese Patent Application No. 202210517924.3, filed on May 13, 2022, the entire contents of which are incorporated herein by reference.

### TECHNICAL FIELD

This invention relates to the power electronics, in particular to the power drive technology and inverter technology.

### BACKGROUND

It is well known that conventional inverter circuits, commonly used in motor drives and grid-connected photovoltaic systems, typically employ half-bridge or full-bridge structures. These circuits require both high and low side power transistor for the output pull-up and pull-down operation, respectively. The high-side transistor, configured as either a source follower or emitter follower, requires its gate or base voltage to be raised above the supply voltage for proper switching. Consequently, the driver circuit must provide a voltage higher than the supply voltage to control the high-side transistor's switching. In lower voltage applications, driver ICs usually use PN junction or SOI isolation on a single IC, employing level-shifting circuits to convert low-voltage PWM control signals into high-voltage PWM signals for driving the high-side transistor. In higher voltage applications, multiple-IC solutions are required, with physical isolation between high and low voltage domains achieved using optical isolators, capacitive isolation, or miniature transformer electromagnetic isolation. These methods allow the low-voltage control IC's PWM signal to be transferred to the high-voltage driver IC, enabling high-voltage PWM output. However, conventional half-bridge or full-bridge inverter circuits have the following limitations:

### CROSS REFERENCE TO THE RELATED APPLICATIONS

This application is the national phase entry of International Application No. PCT/CN2023/093791, filed on May 12, 2023, which is based upon and claims priority to Chinese Patent Application No. 202210517924.3, filed on May 13, 2022, the entire contents of which are incorporated herein by reference.

### TECHNICAL FIELD

This invention relates to the power electronics, in particular to the power drive technology and inverter technology.

### BACKGROUND

It is well known that conventional inverter circuits, commonly used in motor drives and grid-connected photovoltaic systems, typically employ half-bridge or full-bridge structures. These circuits require both high and low side power transistor for the output pull-up and pull-down operation, respectively. The high-side transistor, configured as either a source follower or emitter follower, requires its gate or base voltage to be raised above the supply voltage for proper switching. Consequently, the driver circuit must provide a voltage higher than the supply voltage to control the high-side transistor's switching. In lower voltage applications, driver ICs usually use PN junction or SOI isolation on a single IC, employing level-shifting circuits to convert low-voltage PWM control signals into high-voltage PWM signals for driving the high-side transistor. In higher voltage applications, multiple-IC solutions are required, with physical isolation between high and low voltage domains achieved using optical isolators, capacitive isolation, or miniature transformer electromagnetic isolation. These methods allow the low-voltage control IC's PWM signal to be transferred to the high-voltage driver IC, enabling high-voltage PWM output. However, conventional half-bridge or full-bridge inverter circuits have the following
1. Fixed Output Voltage: The peak output voltage of conventional inverters is constrained by the supply voltage. Even with SVPWM modulation, the maximum output voltage amplitude can only be increased to approximately 1.15 times of the supply voltage.
2. Voltage Limitation Due to High-Side Driver: The supply voltage of the inverter cannot be significantly increased due to limitations in the high-side driver IC. Although modern power devices is capable of withstanding kilovolt-level voltages, the high-side transistor requires a driver circuit to provide a PWM signal with an amplitude higher than the supply voltage. This presents a challenge for the driver IC and restricts the inverter's overall operating voltage.
3. Power Output Reduction Due to Dead Time: In half-bridge or full-bridge structures, dead time must be introduced to prevent simultaneous conduction of the high-side and low-side transistors, which could result in a short circuit. This dead time reduces the inverter's effective power output.
4. Reliability Issues from High dv/dt: During switching, a large dv/dt can occur, especially when the high-side transistor turns on while the low-side transistor is off. This high dv/dt can induce parasitic capacitance effects, causing unwanted gate triggering in the low-side transistor and potential misoperation in the low-voltage control circuits, significantly impacting inverter reliability.
5. Complex Control Algorithm and High IC Cost: Conventional inverters based on half-bridge or full-bridge structures typically require SPWM or SVPWM modulation, which demands complex algorithms for controlling the PWM duty cycle, particularly in applications such as main motor drives for electric vehicles. Additionally, multiple isolated high- and low-side driver ICs are required, increasing system cost.

FIG. 1 illustrates the principle of a conventional three-phase half-bridge inverter structure, which uses both high and low-side power switches to drive a three-phase motor. The high dv/dt across the devices can cause false triggering, logic errors, and even motor insulation breakdown between the stator and rotor.

### SUMMARY

The technical problem addressed by this invention is to provide an inverter circuit with absolutely no high-side power transistors that offers higher inverter voltage and power output capabilities than existing technologies, while eliminating the reliability issues caused by high dv/dt in conventional inverter structures.

The proposed invention utilizes a novel circuit structure, characterized by at least two inverter modules connected in a ring configuration. In this structure, the output terminal of the modulation signal from the preceding inverter module is connected to the input terminal of the modulation signal in the subsequent inverter module. The output terminal of the final inverter module's modulation signal is connected to the input terminal of the first inverter module's modulation signal. Each inverter module includes the following:
Pre-Filter Circuit, with a signal input terminal and signal output terminal, where the signal input terminal serves as the modulation signal input.
Mid-Filter Circuit, with a direct current (DC) power input and alternating current (AC) power output coil. The input terminal of the mid-filter circuit is connected to the output terminal of the pre-filter circuit.
Signal Output Circuit, with its input connected to the output of the mid-filter circuit and its output serving as the modulation signal output.

In further detail, the pre-filter circuit includes a pre-filter capacitor and pre-filter inductor, with one end of the pre-filter inductor grounded and the other connected to the signal output terminal. One end of the pre-filter capacitor serves as the input, and the other end connects to the signal output terminal of the pre-filter circuit.

The mid-filter circuit includes a rectifier diode, compensation capacitor, first inductive component, and second inductive component. The positive end of the rectifier diode serves as the signal input, and the negative end connects to the signal output via the first inductive component. The negative end is also grounded through the compensation capacitor. The DC power input is connected to the signal output terminal via the second inductive component. The AC power output coil may be either the first or second inductive component.

The signal output circuit includes a first switching component and a compensation inductor, with one end of the compensation inductor connected to the input and the other to the output of the signal output circuit. The output is grounded via the first switching component, whose control terminal serves as the low-frequency control signal input.

Additionally, a supply capacitor connects the DC power input to the mid-filter circuit's signal output.

A mid-filter capacitor is placed between the input and output terminals of the mid-filter circuit.

The invention also includes a chopper, with a high-frequency control signal input. The chopper is connected to either end of the second inductive component or to the modulation signal output.

The chopper circuit includes a high-frequency control signal input terminal. The chopper circuit is connected to either end of the second inductive component 25, or alternatively, it connects to the modulation signal output terminal.

Specifically, the chopper includes a second switching device and a diode connected in series between the modulation signal output terminal and the ground level terminal. The control terminal of the second switching device serves as the input terminal for the high-frequency control signal.

The second switching device and a diode are connected in series between the modulation signal output terminal and the ground level terminal.

In a preferred embodiment, three inverter modules are connected in a ring configuration, corresponding to three-phase AC current

This invention allows the inverter to achieve a peak sinusoidal output voltage that exceeds the DC supply voltage, enabling higher voltage and power output under a given DC supply.

By eliminating the half-bridge or full-bridge structure, the invention also resolves several reliability issues, such as unintended switching of the low-side power device and the reduced energy utilization caused by dead time in conventional designs. As a result, the inverter's reliability is significantly enhanced.

Furthermore, the invention reduces overall cost, simplifies control algorithms, and lowers the requirements for battery management systems in electric vehicle applications, thereby reducing vehicle costs.

### BRIEF DESCRIPTION OF THE DRAWINGS

FIG. 1: Diagram of an existing half-bridge-based three-phase motor drive structure.

FIG. 2: Schematic of the overall structure of the present invention.

FIG. 3: The circuit of the inverter module for the embodiment 1.

FIG. 4: The circuit of the inverter module for the embodiment 2.

FIG. 5: The circuit of the inverter module for the embodiment 3.

FIG. 6: The circuit of the inverter module for the embodiment 4.

FIG. 7: The circuit of the inverter module for the embodiment 5.

FIG. 8: The circuit of the inverter module for the embodiment 6.

FIG. 9: The circuit of the inverter module for the embodiment 7.

FIG. 10: The circuit of the inverter module for the embodiment 8.

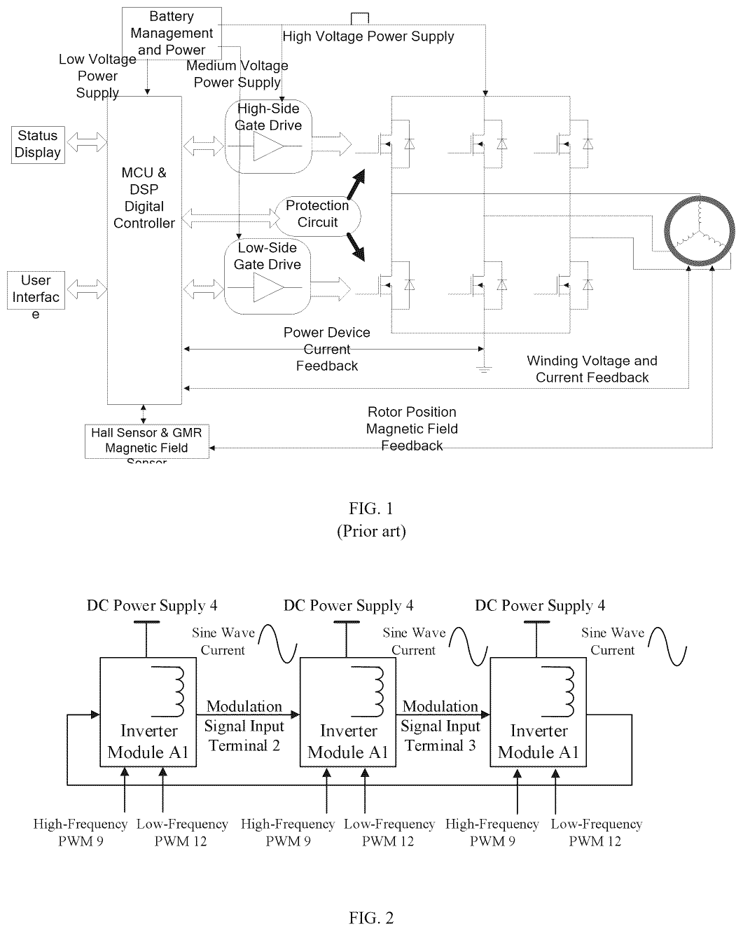

### DETAILED DESCRIPTION OF THE EMBODIMENTS

### Legend for the Figures

2: Modulation signal input terminal
3: Modulation signal output terminal
4: DC power supply
9: High-frequency PWM signal
12: Low-frequency PWM signal
16: Pre-filter capacitor
17: Pre-filter inductor
18: Rectifier diode
19: Compensation capacitor
20: First inductive component
21: Supply capacitor
22: First switching component
23: Compensation inductor
24: Electromotive force (EMF)
25: Second inductive component
26: Power inductor
27: Second switching component
28: Low-frequency control diode
29: A terminal of the inverter winding
30: B terminal of the inverter winding
31: High-frequency control diode
32: Mid-filter capacitor

Referring to FIG. 2, the invention provides an inverter circuit without high-side power transistors, where at least two inverter modules are connected in a ring structure. In this structure, the modulation signal output terminal of the previous inverter module is connected to the modulation signal input terminal of the subsequent inverter module. The modulation signal output terminal of the last inverter module is connected to the modulation signal input terminal of the first inverter module, forming a closed loop.

In more detail, the inverter modules in the ring structure are sequentially numbered in a predetermined direction (e.g., clockwise), with any inverter module potentially serving as the first module. If numbered as 1, subsequent modules are labeled as 2, 3, . . . . N. In adjacent modules, the modulation signal output terminal of the module numbered x-1 is connected to the modulation signal input terminal of the module numbered x, and the modulation signal output terminal of the module numbered N (the last one) is connected to the modulation signal input terminal of the module numbered 1, creating a closed-loop system. N is a predetermined natural number equal to the number of inverter modules, and x is a natural number between 2 and N.

Preferred Example: FIG. 2 shows a closed loop consisting of three inverter modules, labeled A1, A2, and A3. Each inverter module has an inverter winding that outputs AC power (sine wave current) and acts as a stator winding. The windings of the first, second, and third inverter modules are labeled u1-u2, v1-v2, and w1-w2, respectively, corresponding to three-phase AC power. The invention is not limited to three inverter modules, and more modules may be used. Each inverter module has a high-frequency control signal input (high-frequency PWM) and a low-frequency control signal input (low-frequency PWM).

### Embodiment 1

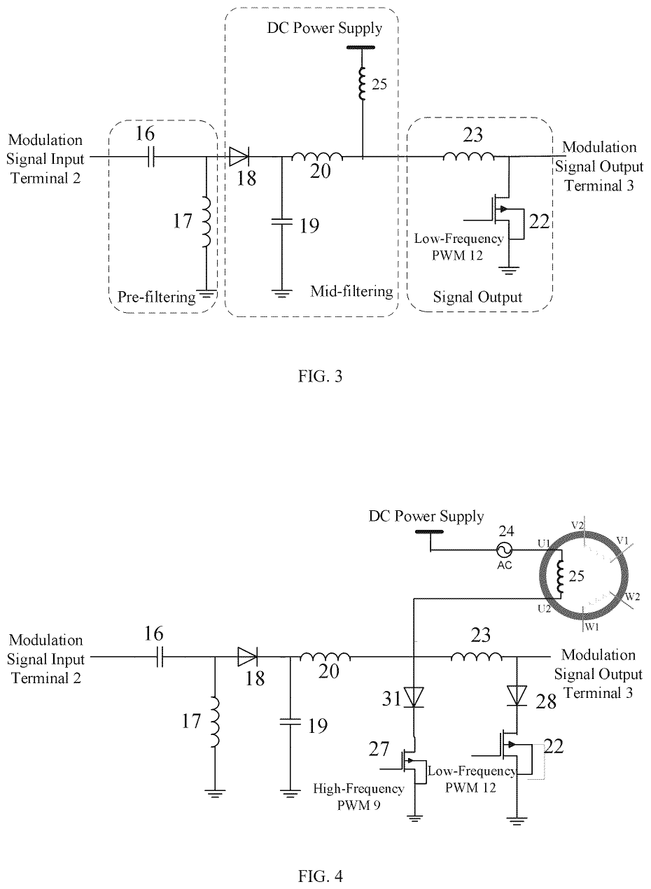

Referring to FIGS. 2 and 3, this embodiment consists of three inverter modules connected in a ring. Each inverter module includes:

Pre-filter Circuit, with signal input and output terminals. The signal input terminal serves as the modulation signal input terminal. The pre-filter circuit includes pre-filter capacitor 16 and pre-filter inductor 17. One end of pre-filter inductor 17 is grounded, and the other is connected to the signal output terminal of the pre-filter circuit. One end of pre-filter capacitor 16 serves as the input terminal, and the other end is connected to the signal output terminal of the pre-filter circuit.

Mid-filter Circuit, with a DC power input and an AC power output coil (the inverter winding mentioned earlier). The input terminal of the mid-filter circuit is connected to the output terminal of the pre-filter circuit. The mid-filter circuit includes rectifier diode 18, compensation capacitor 19, first inductive component 20, and second inductive component 25. The positive end of rectifier diode 18 serves as the input terminal of the mid-filter circuit, and its negative end is connected to the output terminal of the mid-filter circuit via first inductive component 20. The negative end is also grounded via compensation capacitor 19. The DC power input is connected to the output terminal via second inductive component 25. The AC power output coil is either the first inductive component 20 or the second inductive component 25.

Signal Output Circuit, with its input connected to the output of the mid-filter circuit and its output serving as the modulation signal output terminal. The signal output circuit includes first switching component 22 and compensation inductor 23. One end of compensation inductor 23 is connected to the input of the signal output circuit, and the other end is connected to its output. The output is grounded through first switching component 22, whose control terminal serves as the low-frequency control signal input. The low-frequency control signal is provided by a low-frequency PWM signal.

In this embodiment, only pull-down devices are used, and pull-up devices are eliminated, significantly improving reliability.

### Embodiment 2

Referring to FIG. 4, this embodiment further improves upon Embodiment 1. Second inductive component 25 is used as the AC power output coil, with 24 representing the electromotive force (EMF) generated by the AC output coil. One end of second inductive component 25, near the DC power input, is designated as terminal A, and the other end is terminal B.

This embodiment also includes a chopper, with a high-frequency control signal input terminal. The chopper is connected to terminal B of second inductive component 25. The chopper consists of a high-frequency control diode 31 and second switching component 27 in series. The second switching component, a MOSFET, has its gate connected to the high-frequency control signal input.

The chopper allows the output waveform to more closely approximate a standard sine wave.

### Embodiment 3

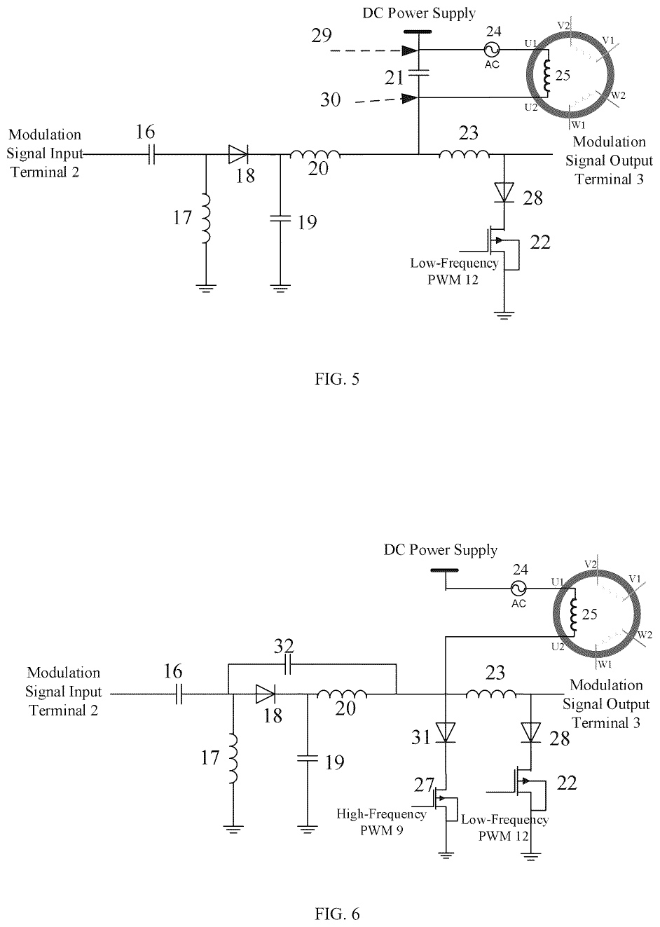

Referring to FIG. 5, this embodiment builds upon Embodiment 1 by adding a supply capacitor 21, which is connected in parallel with second inductive component 25. That is, it is placed between terminals A and B of second inductive component 25.

Additionally, a low-frequency control diode 28 is added. The anode of low-frequency control diode 28 is connected to modulation signal output terminal 3, and the cathode is grounded via first switching component 22, which is a MOSFET.

This embodiment improves the output AC waveform by making it closer to a standard sine wave and prevents voltage spikes in the output waveform.

### Embodiment 4

Referring to FIG. 6, this embodiment builds upon Embodiment 2 by adding a mid-filter capacitor 32, connected between the input and output terminals of the mid-filter circuit.

By adding the mid-filter capacitor, the output AC waveform is further improved, producing a more standard sine wave, offering a more substantial improvement compared to Embodiment 2.

### Embodiment 5

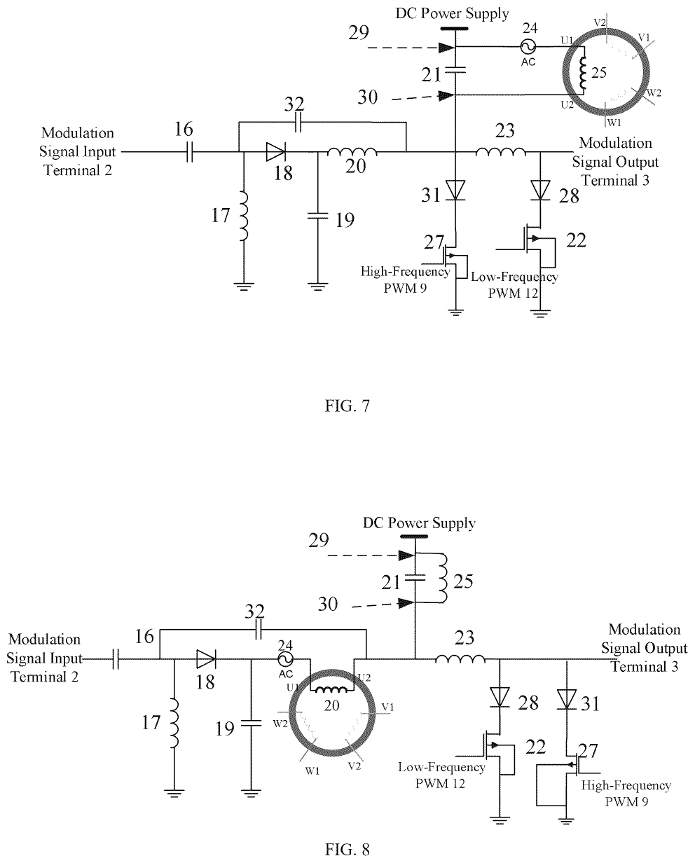

Referring to FIG. 7, this embodiment builds upon Embodiment 4 by adding a supply capacitor 21, placed between terminals A and B of second inductive component 25.

In this embodiment, the output waveform of the inverter winding more closely resembles a standard sine wave.

### Embodiment 6

As shown in FIG. 8, in this embodiment, the chopper circuit is connected to the modulation signal output terminal (3). The chopper circuit consists of a series connection of a high-frequency control diode (31) and a second switching device (27). In this embodiment, the inverter winding for external AC output is the first inductive component (20).

Compared to embodiments where the second inductive component (25) is used as the inverter winding, using the first inductive component (20) in this embodiment allows for a larger output current under the same conditions.

### Embodiment 7

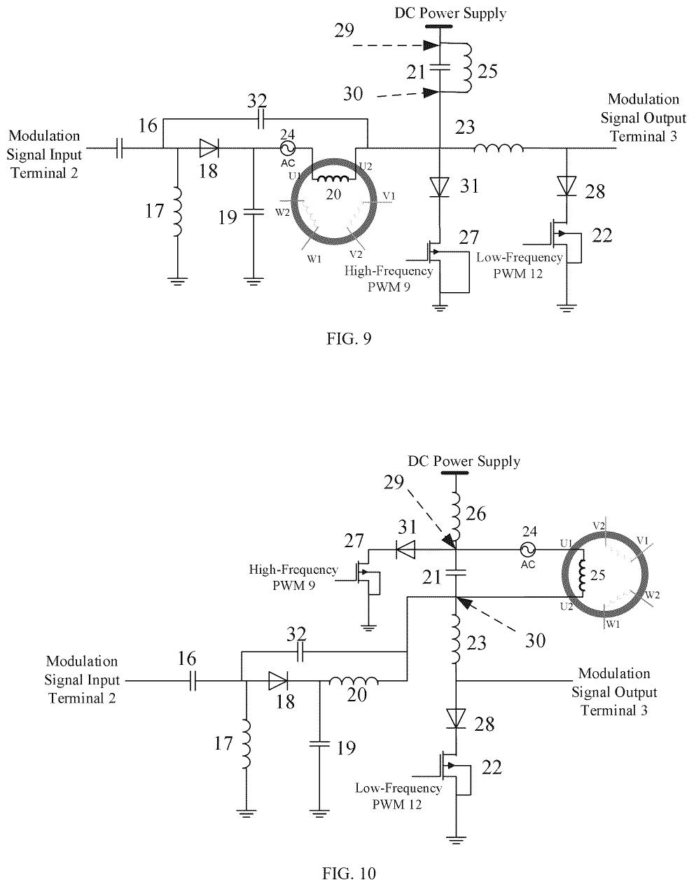

As shown in FIG. 9, unlike Embodiment 6, in this embodiment, the chopper circuit is connected to the input terminal of the signal output circuit. The chopper circuit also consists of a series connection of a high-frequency control diode (31) and a second switching device (27). In this embodiment, the first inductive component (20) serves as the inverter winding for external AC output.

Under the same conditions, this embodiment provides a larger output current by using the first inductive component (20) as the inverter winding instead of the second inductive component (25).

### Embodiment 8

As shown in FIG. 10, in this embodiment, the second inductive component (25) is used as the inverter winding for external AC output. Its A terminal (29) is connected to the DC power supply through a power inductor (26). The chopper circuit, consisting of the high-frequency control diode (31) and the second switching device (27), is connected to the A terminal (29) of the second inductive component (25).

In this embodiment:

The pre-filtering circuit is composed of a pre-filtering capacitor (16) and a pre-filtering inductor (17). A high-frequency power transistor is used as the second switching device (27), which, along with the high-frequency control diode (31), forms a multiplication chopper circuit.

The gate of the second switching device (27) serves as the input terminal for the high-frequency control signal. The rectifier diode (18), compensation capacitor (19), first inductive component (20), middle capacitor (32), power capacitor (21), power inductor (26), and second inductive component (25) form the mid-stage filtering circuit.

During operation, the input signal at the modulation signal input terminal (2) consists of three components:
(a) a DC component,
(b) a first harmonic low-frequency sine wave component (referred to as the low-frequency component), and
(c) a high-frequency component resulting from the PWM modulation from the previous stage (referred to as the high-frequency component).

After passing through the pre-filter circuit, the DC component is filtered out, leaving the low-frequency and high-frequency components. The low-frequency component and the demodulated high-frequency component create a differential voltage, which drives the inverter winding (25).

In other words, the high-frequency component is sent to the A terminal (29) of the inverter winding through the middle capacitor (32) and the power capacitor (21) and undergoes multiplication demodulation in the chopper circuit. This results in a sine wave with the same frequency as the low-frequency PWM signal and higher-frequency harmonic components. The resulting sine wave and harmonic components are filtered by the power capacitor (21), the inverter winding (25), and the power inductor (26), removing the high-frequency signal and producing a standard sine wave with a frequency matching the low-frequency PWM signal (12) and a phase shift.

Meanwhile, the first harmonic low-frequency sine wave component output from the pre-filter circuit passes through the rectifier diode (18) and the compensation capacitor (19), obtaining DC boost and generating a first harmonic sine wave signal with both DC voltage and low-frequency PWM driving signals. The low-frequency PWM driving signal is generated by the low-frequency PWM drive in the previous inverter module.

This first harmonic sine wave signal is then input into the B terminal (30) of the inverter winding (25). The low-frequency PWM signal in this stage drives the low-frequency power transistor (22) of this inverter module, producing a square wave, which generates a first sine wave harmonic current signal with a DC component in the inverter winding. This combines with the sine wave current demodulated and filtered from the modulation signal input (2) to generate the final sine current (14), thereby driving the inverter winding (25).

Thus, there are three sources of sine wave current in the inverter winding (25): (1) The first harmonic low-frequency sine wave current from the previous inverter module, (2) The high-frequency modulated and demodulated sine wave current from the previous inverter module, and (3) The first harmonic low-frequency sine wave current generated by this inverter module.

The multiplication chopper circuit, composed of the high-frequency power transistor (27) and controlled by the high-frequency PWM signal, not only demodulates the high-frequency modulation signal from the previous stage but also modulates the sine current in the inverter winding. This generates a high-frequency modulation signal at the B terminal (30), which, along with the sine half-wave signal generated by the low-frequency power transistor (22) driven by the low-frequency PWM (12), is sent to the next inverter module.

In this embodiment, the inverter winding outputs a standard sine wave free of spikes and DC components.

What is claimed is:

1. An inverter circuit without high-side power transistors, comprising at least two inverter modules connected in a ring structure, wherein a modulation signal output terminal of a preceding inverter module is connected to a modulation signal input terminal of a subsequent inverter module, and a modulation signal output terminal of a last inverter module is connected to a modulation signal input terminal of a first inverter module; wherein each inverter module comprises:
a pre-filter circuit having a signal input terminal and a signal output terminal, wherein the signal input terminal serves as the modulation signal input terminal;
a mid-filter circuit having a direct current (DC) power input terminal and an alternating current (AC) power output coil, wherein a signal input terminal of the mid-filter circuit is connected to the signal output terminal of the pre-filter circuit;
a signal output circuit, wherein a signal input terminal of the signal output circuit is connected to a signal output terminal of the mid-filter circuit, and a signal output terminal of the signal output circuit serves as the modulation signal output terminal.

2. The inverter circuit without the high-side power transistors according to claim 1, wherein
the pre-filter circuit comprises a pre-filter capacitor and a pre-filter inductor, wherein a first end of the pre-filter inductor is grounded, and a second end of the pre-filter inductor is connected to the signal output terminal of the pre-filter circuit; the pre-filter capacitor comprises a first end serving as the signal input terminal of the pre-filter circuit and a second end serving as the signal output terminal of the pre-filter circuit;
the mid-filter circuit comprises a rectifier diode, a compensation capacitor, a first inductive component, and a second inductive component, wherein a positive terminal of the rectifier diode serves as the signal input terminal of the mid-filter circuit, and a negative terminal of the rectifier diode is connected to the signal output terminal of the mid-filter circuit through the first inductive component, and further grounded through the compensation capacitor; the DC power input terminal is connected to the signal output terminal of the mid-filter circuit through the second inductive component; the AC power output coil is the first inductive component or the second inductive component;
the signal output circuit comprises a first switching device and a compensation inductor, wherein a first end of the compensation inductor is connected to the signal input terminal of the signal output circuit, and a second end of the compensation inductor is connected to the signal output terminal of the signal output circuit, the signal output terminal of the signal output circuit is grounded through the first switching device, and a control terminal of the first switching device serves as a low-frequency control signal input terminal.

3. The inverter circuit without the high-side power transistors according to claim 2, wherein the DC power input terminal is further connected to the signal output terminal of the mid-filter circuit through a power supply capacitor.

4. The inverter circuit without the high-side power transistors according to claim 2, wherein a mid-capacitor is disposed between the signal input terminal and the signal output terminal of the mid-filter circuit.

5. The inverter circuit without the high-side power transistors according to claim 2, further comprising a chopper, wherein the chopper has a high-frequency control signal input terminal and is connected to an end of the second inductive component, or to the modulation signal output terminal.

6. The inverter circuit without the high-side power transistors according to claim 4, further comprising a chopper, wherein the chopper has a high-frequency control signal input terminal and is connected to an end of the second inductive component, or to the modulation signal output terminal.

7. The inverter circuit without the high-side power transistors according to claim 5, wherein the chopper comprises a second switching device and a diode-connected in series between the modulation signal output terminal and ground, and a control terminal of the second switching device serves as the high-frequency control signal input terminal.

8. The inverter circuit without the high-side power transistors according to claim 2, wherein a second switching device and a diode are connected in series between the modulation signal output terminal and ground.

9. The inverter circuit without the high-side power transistors according to claim 2, wherein the AC power output coil is the second inductive component, and a mid-capacitor is disposed between the signal input terminal and signal output terminal of the mid-filter circuit, and a power supply capacitor is connected across both ends of the second inductive component, wherein an A terminal of the second inductive component is connected to the DC power input terminal via a supply inductor, and a chopper is connected to the A terminal of the second inductive component, wherein the chopper comprises a second switching device and a diode connected in series between the modulation signal output terminal and ground, and a control terminal of the second switching device serves as the high-frequency control signal input terminal.

10. The inverter circuit without the high-side power transistors according to claim 1, wherein the ring structure comprises three inverter modules.

11. An inverter module without high-side power transistors, comprising
a pre-filter circuit having a signal input terminal and a signal output terminal, wherein the signal input terminal serves as a modulation signal input terminal;
a mid-filter circuit having a DC power input terminal and an AC power output coil, wherein a signal input terminal of the mid-filter circuit is connected to the signal output terminal of the pre-filter circuit;
a signal output circuit, wherein a signal input terminal of the signal output circuit is connected to a signal output terminal of the mid-filter circuit, and a signal output terminal of the signal output circuit serves as a modulation signal output terminal;
the pre-filter circuit comprises a pre-filter capacitor and a pre-filter inductor, wherein a first end of the pre-filter inductor is grounded, and a second end of the pre-filter inductor is connected to the signal output terminal of the pre-filter circuit; the pre-filter capacitor comprises a first end serving as the signal input terminal of the pre-filter circuit and a second end serving as the signal output terminal of the pre-filter circuit;
the mid-filter circuit comprises a rectifier diode, a compensation capacitor, a first inductive component, and a second inductive component, wherein a positive terminal of the rectifier diode serves as the signal input terminal of the mid-filter circuit, and a negative terminal of the rectifier diode is connected to the signal output terminal of the mid-filter circuit through the first inductive component, and further grounded through the compensation capacitor; the DC power input terminal is connected to the signal output terminal of the mid-filter circuit through the second inductive component; the AC power output coil is the first inductive component or the second inductive component;
the signal output circuit comprises a first switching device and a compensation inductor, wherein a first end of the compensation inductor is connected to the signal input terminal of the signal output circuit, and a second end of the compensation inductor is connected to the signal output terminal of the signal output circuit, the signal output terminal of the signal output circuit is grounded through the first switching device, and a control terminal of the first switching device serves as a low-frequency control signal input terminal.

12. The inverter module without the high-side power transistors according to claim 11, wherein the DC power input terminal is further connected to the signal output terminal of the mid-filter circuit through a power supply capacitor.

13. The inverter module without the high-side power transistors according to claim 11, wherein a mid-capacitor is arranged between the signal input terminal and the signal output terminal of the mid-filter circuit.

14. The inverter module without the high-side power transistors according to claim 11, further comprising a chopper, wherein the chopper has a high-frequency control signal input terminal, and the chopper is connected to a terminal of the second inductive component, or the chopper is connected to the modulation signal output terminal.

15. The inverter module without the high-side power transistors according to claim 13, further comprising a chopper, wherein the chopper has a high-frequency control signal input terminal, and the chopper is connected to a terminal of the second inductive component, or the chopper is connected to the modulation signal output terminal.

16. The inverter module without the high-side power transistors according to claim 14, wherein the chopper comprises a second switching device and a diode connected in series between the modulation signal output terminal and a ground level terminal, wherein a control terminal of the second switching device serves as the high-frequency control signal input terminal.

17. The inverter module without the high-side power transistors according to claim 11, wherein a second switching device and a diode are connected in series between the modulation signal output terminal and a ground level terminal.

18. The inverter module without the high-side power transistors according to claim 11, wherein the AC power output coil is the second inductive component, a mid-capacitor is arranged between the signal input terminal and the signal output terminal of the mid-filter circuit, a power supply capacitor is connected across both terminals of the second inductive component, an A terminal of the second inductive component is connected to the DC power input terminal via a supply inductor, and a chopper is connected to the A terminal of the second inductive component, the chopper comprises a second switching device and a diode connected in series between the modulation signal output terminal and a ground level terminal, wherein a control terminal of the second switching device serves as the high-frequency control signal input terminal.

19. The inverter circuit without the high-side power transistors according to claim 3, wherein a mid-capacitor is disposed between the signal input terminal and the signal output terminal of the mid-filter circuit.

20. The inverter circuit without the high-side power transistors according to claim 3, further comprising a chopper, wherein the chopper has a high-frequency control signal input terminal and is connected to an end of the second inductive component, or to the modulation signal output terminal.
